(19) United States
(12) Patent Application Publication
(10) Pub. No.: US 2026/0063590 A1
(43) Pub. Date: Mar. 5, 2026

(54) Device for Measuring Thickness of Pipelines

(71) Applicant: PETRÓLEO BRASILEIRO S.A. - PETROBRAS, Rio de Janeiro (BR)

(72) Inventors: Joao Paulo Urbano, Macaé (BR); Samuell Costa de Souza, Macaé (BR)

(73) Assignee: PETRÓLEO BRASILEIRO S.A. - PETROBRAS, Rio de Janeiro, RJ (BR)

(21) Appl. No.: 19/309,921

(22) Filed: Aug. 26, 2025

(30) Foreign Application Priority Data
Aug. 29, 2024 (BR) 1020240177541

(51) Int. Cl. G01N 29/22; B25J 15/00; B25J 19/00; G01B 17/02; G01N 29/04

(52) U.S. Cl. CPC G01N 29/225; B25J 15/0019; B25J 19/0091; G01B 17/02; G01N 29/04; G01N 2291/02854; G01N 2291/0289; G01N 2291/262

(57) ABSTRACT

The invention is part of the field of inspection technologies, materials, equipment and corrosion, more specifically, of the field of equipment for measuring thickness in subsea pipelines. For this purpose, the present invention describes a device for measuring thickness of pipelines comprising: a manipulator, configured to be the contact region with an ROV; an impact absorber, configured to absorb the horizontal impact of the device; at least two turning devices, configured to be the devices that enable the rotation of the device; a “c” shaped joint; a measurement adapter, comprising: a support, a base of the prism, a magnet prism, at least one pair of rectangular magnets, and at least two pairs of circular magnets; a “T” shaped support; and a mini camera support. Thus, the invention, as it does not require an electrical or hydraulic system, is considered more robust and less prone to failure, in addition to being safer for the environment. In addition, it generates greater ease of manufacture, maintenance, transportation, handling by the ROV and flexibility of general use, in addition to providing greater safety in the operations.

### CROSS-REFERENCE TO RELATED APPLICATIONS

This application claims priority to Brazilian Application No. BR1020240177541 filed on Aug. 29, 2024, the disclosure of which is expressly incorporated herein by reference in its entirety.

### FIELD OF THE INVENTION

The present invention is part of the field of inspection technologies, materials, equipment and corrosion, more specifically, of the field of measuring equipment. The present invention, even more specifically, is part of the field of equipment for measuring thickness in subsea pipelines and equipment.

### BACKGROUND OF THE INVENTION

The subsea structures (WCT, manifold, PLET, etc.) periodically require thickness measurements to check for the internal corrosion, where some of these locations are pipelines and piping. In this way, the thickness measurement is one of the most important structural integrity management activities to ensure the operational safety, whether for people, assets or the environment.

Currently, only part of the regions programmed in subsea equipment for thickness measurement by means of ROVs (remotely operated robots) are being carried out, due to the difficulty of accessing more restricted locations. Thus, most of the non-accessible regions are opposite generatrices of pipelines in relation to the position of the ROV. For example, in subsea structures, measurements are required in four generatrices of the pipelines, which are: frontal, both lateral and opposite, always in relation to the position of the ROV. The opposite position, that is, “behind” the pipeline in relation to the ROV, has always been a challenge to measure.

The tools commercially available on the market were developed to measure regions more exposed frontally to the ROV, thus depending on the degree of freedom and movements of the ROV to be able to inspect the lateral regions of the piping. Consequently, with the current resources, it has not been possible to measure part of the opposite regions (generatrices) of the piping.

Only a part of these opposite regions are currently measured. This creates risks for the integrity management of these subsea structures, since it limits knowledge about the internal quality of the piping. Even the lateral regions of the piping are not always measured depending on restrictions or nearby obstacles.

The thickness measurements are performed with the ROV docked in most cases, in order to achieve sufficient stability to obtain a reading of the measured thickness.

In this way, the objective of the device of the present invention is to access these and other more restricted regions by means of a robust, adaptive, practical, low-cost and easy-to-implement tool.

Thus, the percentage of inspected regions in relation to those programmed would increase disruptively, to an expected reach in almost all programmed regions.

The device of the present invention will also allow inspection with the ROV without being docked, due to the spring device of the solution, and can be applied in any area that uses ROVs for ultrasonic thickness measurement.

### RELATED ART

The state of the art includes documents that disclose technologies related to the technology of the present invention, as described below.

Document of the state of the art CN 105158336 A describes a multifunctional ultrasonic phased array piping circumferential weld detection equipment comprising a main body, a magnetic pressure wheel mechanism, an auxiliary support, a fastening device, a left flaw detection probe bracket, a right flaw detection probe bracket, a left flaw detection probe and a right flaw detection probe.

Document of the state of the art US2016320282 A1 describes systems, apparatus and methods for measuring submerged surfaces. The embodiments include a measuring apparatus including a main structure, a source positioned outside a pipe and connected to the main structure and a detector positioned outside the pipe at a location diametrically opposite the source and connected to the main structure.

Document of the state of the art US2016231281 A1 describes systems, apparatus and methods including a piping inspection apparatus comprising a carriage, a first member including at least a first and a second sensor configured to perform a first round of measurements of a pipe, a second member including at least a third and fourth sensor configured to perform a first round of measurements of the pipe and a multiplexer.

Document of the state of the art US2020173879 A1 describes devices and methods for conducting pipelines inspection operations. The embodiments may include a robotic crawler or other devices having a plurality of arms, carrying imaging equipment such as radiation sources and linear detectors disposed on or coupled to the arms of the plurality of arms.

Document of the state of the art US2014260705 A1 describes apparatus for inspecting the external surface of a pipe. The apparatus may include a carriage adapted to rotate a pipe to be inspected and includes a pipe inspection head.

Considering the matter described in these documents found in the state of the art, first, it is important to note that all the documents and tools cited are heavier and more complex than the tool proposed by the present invention. This is due to the fact that all the technologies cited in the state of the art present a greater number of sensors, when compared to the tool of the present invention, which uses only one sensor. In addition, all the tools presented in the state of the art are significantly large in all their dimensions, making stability during inspection difficult. In addition, the ultrasound piping analysis systems of the present invention differ from the system disclosed by the documents of the state of the art.

Another important factor is the absence of the camera system in the documents of the state of the art, as well as the lack of versatility in reaching hard-to-reach regions. In turn, the proposed invention provides the possibility of operating on the diameters of all pipping required for subsea inspection, since it is possible to couple the same to any piping diameter and even to non-straight piping or flat surfaces.

Furthermore, it is worth noting that, among the documents in the state of the art, only document CN 105158336 A describes a system for absorbing impact, which operates differently compared to the present invention.

In this way, the present invention, when compared to the five tools already disclosed in the state of the art, presents greater flexibility and access to locations further away from the ROV, these locations being more restricted and difficult to access. The present invention presents a much simpler, more common, safer and more objective methodology, much better impact absorption, generating safety and stability in the measurement, a magnetic system that gives the freedom to perform remote measurements and at any angle of the piping, much lower weight and greater compactness, generating practicality and agility in the inspections.

### SUMMARY OF THE INVENTION

The present invention describes a device for measuring thickness of pipelines (100) comprising: a manipulator (110), configured to be the contact region with an ROV; an impact absorber (120), configured to absorb the horizontal impact of the device (100); at least two turning devices (130, 140), configured to be the devices that enable the rotation of the device (100); a “c” shaped joint (12); a measurement adapter (150), comprising: a support (13), a base of the prism (17), a magnet prism (20), at least one pair of rectangular magnets (18), and at least two pairs of circular magnets (19); a “T” shaped support (15); and a mini camera support (16).

Thus, the invention, since it does not require an electrical or hydraulic system, is considered more robust and less prone to failure, in addition to being safer for the environment. In addition, the structural weight of the device of the present invention is much lower considering the state of the art, generating greater ease of manufacture, maintenance, transportation, handling by the ROV and flexibility of general use, in addition to greater safety in the operations. The size and weight of the device of the proposed invention also allow it to be transported by the ROV itself between the ship and the subsea inspection site.

### BRIEF DESCRIPTION OF THE DRAWINGS

In order to obtain a complete and total view of the object of this invention, the figures to which references are made are presented, as follows.

FIG. 1 shows the device for measuring thickness, according to the present invention.

FIG. 2 shows both side views of the device for measuring thickness, according to the present invention.

FIG. 3 shows both front and rear views of the device for measuring thickness, according to the present invention.

FIG. 4 shows the measuring adapter of the device for measuring thickness, according to the present invention.

FIG. 5 shows the movement of the base of the prism in relation to the measuring adapter support of the device for measuring thickness, according to the present invention.

FIG. 6 shows the movement of the magnet prism in relation to the base of the prism of the measuring adapter of the device for measuring thickness, according to the present invention.

FIG. 7 illustrates the device for measuring thickness with the first joint in the positioning with a rotation angle of −45°.

FIG. 8 illustrates the device for measuring thickness with the first joint in the positioning with a rotation angle of −90°.

FIG. 9 illustrates the device for measuring thickness with the first joint in the positioning with a rotation angle of −135°.

FIG. 10 illustrates the device for measuring thickness with the first joint in the positioning with a rotation angle of −180°.

FIG. 11 illustrates the device for measuring thickness with the first joint in the positioning with a rotation angle of 0° and the second joint in the positioning with a rotation angle of 45°.

FIG. 12 illustrates the device for measuring thickness with the first joint in the positioning with a rotation angle of 0° and the second joint in the positioning with a rotation angle of −90°.

FIG. 13 illustrates the device for measuring thickness in operation in a pipeline, according to the present invention.

### DETAILED DESCRIPTION OF THE INVENTION

The subsea structures (WCT, manifold, PLET, etc.) periodically require thickness measurements to check for the internal corrosion, where some of these locations are pipelines and piping. In this way, the thickness measurement is one of the most important structural integrity management activities to ensure the operational safety, whether for people, assets or the environment.

However, most of the inaccessible regions are located at opposite generatrices of pipelines in relation to the position of the ROVs (remotely operated robots), which is a challenge to measure, since this is an opposite position, that is, “behind” the pipeline in relation to the ROV.

The commercially available tools on the market were developed to measure regions that are more exposed in front of the ROV; consequently, with the current resources, it has not been possible to measure part of the opposite regions (generatrices) of the piping.

In this way, the objective of the present invention is to access these and other more restricted regions by means of a robust, adaptive, practical, low-cost and easy-to-implement tool.

To this end, the present invention describes a device for measuring thickness of pipelines (100) comprising: a manipulator (110); an impact absorber (120); at least two turning devices (130, 140); a “c” shaped joint (12); a measurement adapter (150); a “T” shaped support (15); and a mini camera support (16).

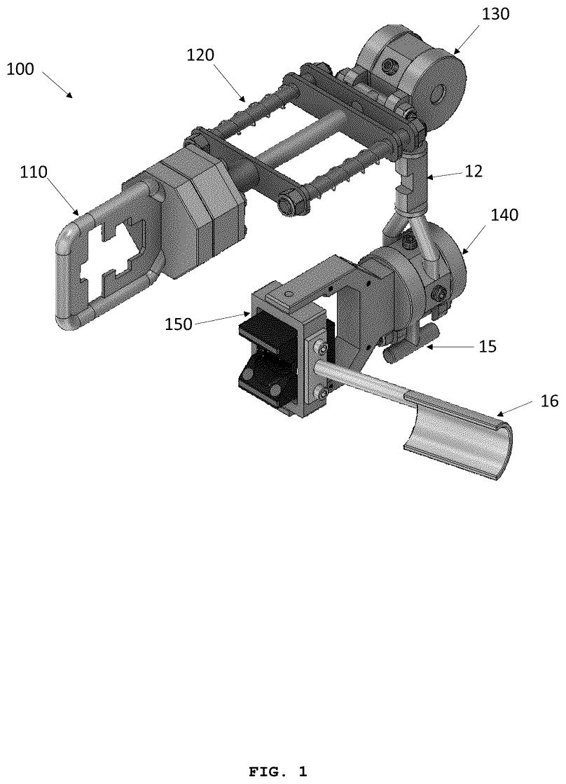

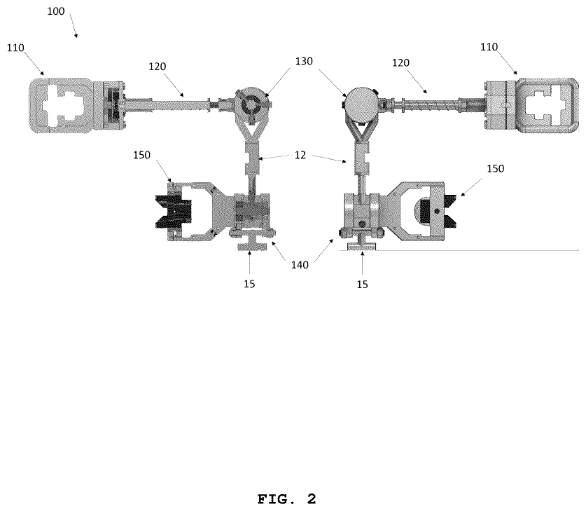

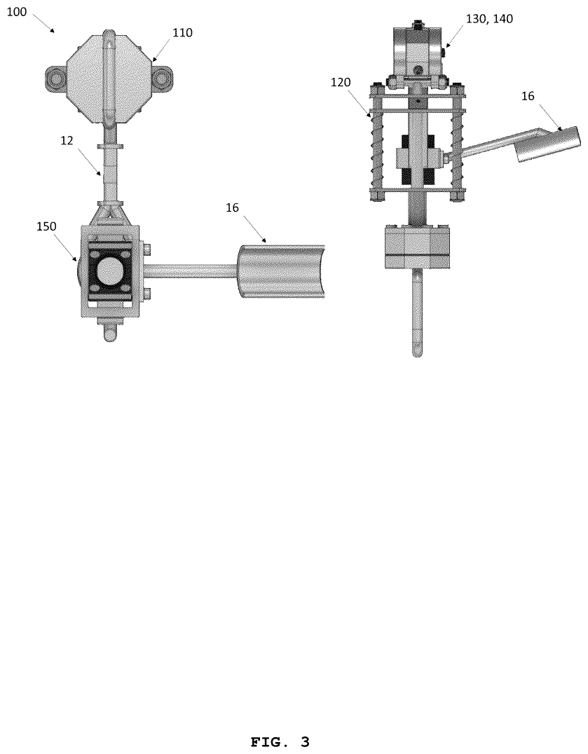

In FIGS. 1, 2 and 3, it is possible to see the arrangement of the presented components of the device for measuring thickness of pipelines (100).

The manipulator is shown, configured to be the contact region with an ROV, comprising: a coupling surface; a male fitting and a female fitting. The male fitting has a T interface for coupling to the female fitting. The female fitting has an interface inside the same for coupling to the T of the male fitting. The female fitting consists of an upper and lateral structure, an upper cushion fitting surface, cushions and a lower cushion fitting surface.

The coupling surface is the surface where the device (100) of the present invention is held by the gripper of a manipulator of a ROV (remotely operated vehicle). In this way, it is by means of this surface that the ROV directs the device (100) to the desired location to perform the operation.

In addition, the coupling surface is also used as one of the points at which the gripper of a ROV holds to perform the rotation movement of one of the at least two turning devices (130, 140), which will be described later.

The male fitting is integral with the coupling surface, and in which the coupling surface is fixed to the male fitting, preferably by means of welding.

The female fitting is integral with the male fitting, so that the female fitting fits into the male fitting, and is fixed to the same by means of a T interface of the male fitting that enters and attaches to the inside of the female fitting. The female fitting is further fixed to the mobile shaft of the impact absorber (120) preferably by means of welding, as can be seen in FIGS. 1, 2 and 3. The T interface of the lower part of the male fitting, when entering the female fitting through the upper linear gap of the latter, makes a 90 degree turn by the movement of the ROV manipulator, and is pushed towards the upper internal linear interface of the female fitting, where said T interface of the lower part of the male fitting will be coupled. The T interface of the lower part of the male fitting is pushed towards the upper part of the female fitting by the force exerted by the upper fitting surface of cushions. Such cushions are between the upper fitting surface and the lower fitting surface. When entering the female fitting by the force of the ROV manipulator, the T interface of the male fitting presses the cushions, receiving in return a force that will push this T interface of the male fitting in the opposite direction, which will contribute to the entry of this T into the internal upper linear interface of the female fitting.

The impact absorber (120) is shown, configured to absorb the horizontal impact of the device (100), which comprises: a first fixed guide; at least two fixed shafts; a mobile shaft; a mobile guide; and a second fixed guide.

The mobile shaft is fixed to the female fitting preferably by means of welding. The first fixed guide has three holes for fitting, one at each end and one in the middle of the first fixed guide. The holes at the ends of the first fixed guide are configured to fix the at least two fixed shafts by means of nuts, and, in which the hole in the middle of the first fixed guide receives the mobile shaft through the same.

The at least two fixed shafts are fixed to the first fixed guide at one of its ends and to the second fixed guide at its other end, and in which the at least two fixed shafts pass through at least two holes at the ends of the mobile guide.

The at least two fixed shafts are surrounded by springs along the length between the first fixed guide and the mobile guide, so that the spring is fixed to the first fixed guide and to the mobile guide, and so that the spring is one of the elements responsible for absorbing the impact of the device when it is being used.

The mobile shaft is fixed to the female fitting at one of its ends and to the mobile guide at its other end, and in which the mobile shaft passes through the hole in the middle of the first fixed guide.

The mobile guide has three holes, one at each end and one in the middle of the mobile guide, so that the holes at the ends receive at least two fixed shafts through the mobile guide, and in which the hole in the middle of the mobile guide is configured to fix one of the ends of the mobile shaft.

The second fixed guide has two holes, one at each end of the second fixed guide, and in which the holes at the ends of the second fixed guide are configured to fix the at least two fixed shafts by means of nuts. The second fixed guide further comprises a connection for the first turning device (130) of the at least two turning devices (130, 140).

The impact absorber (120) operates when the ROV exerts a greater force than necessary to position the device (100).

When exerting a greater force on the manipulator (110), the manipulator (110) will exert a compression force on the impact absorber (120), since it will pull the mobile shaft in the direction of the manipulator (110), pulling the mobile guide towards the manipulator (110), and compressing the springs present along the length between the first fixed guide and the mobile guide, on the at least two fixed shafts, thus absorbing the impact caused by the force of the ROV.

In this way, the impact absorber (120) consisting of a spring generates greater safety for the piping, since it absorbs part of the force of the ROV, further allowing operations to be carried out with the ROV without docking.

The at least two turning devices (130, 140) are shown, configured to be the devices that enable the rotation of the device (100), which comprise, respectively: two external surfaces; an internal bearing; a bearing fixture; two external clamps; and an external fixture.

The two external surfaces are attached to the internal bearing in a movable manner, that is, allowing the two external surfaces to rotate freely in relation to the internal bearing, so that, while the two external surfaces rotate clockwise, the internal bearing rotates counterclockwise in relation to the same, and vice versa.

The internal bearing further has a bearing fixture, through which the external devices are attached to the turning device.

The two external surfaces further comprise two external clamps, through which the external fixture is attached to the two external surfaces by means of nuts, so that the two external surfaces are connected and interconnected. This means that the two external surfaces have the same freedom of rotation, in which they both rotate together, and separately from the internal bearing.

The external fixture is where the external devices are fixed to the turning device.

In this way, the impact absorber (120) is fixed to the external fixture of the first turning device (130). Meanwhile, the “c” shaped joint (12) is fixed to the bearing fixture.

The “c” shaped joint (12) is intended to be a support location for a second gripper on an ROV manipulator.

In this way, to perform the rotation of the first turning device (130), the gripper of one of the manipulators of an ROV must hold the manipulator (110) of the device (100) of the present invention, and the gripper of another manipulator of the ROV must hold the “c” shaped joint (12), and perform the rotation according to the positioning in which the first turning device (130) of the device (100) of the present invention must remain.

The “c” shaped joint (12) is also fixed to the bearing fixture of the second turning device (140). Meanwhile, the “T” shaped support (15) is fixed to the external fixture of the second turning device (140).

The “T” shaped support (15) has the purpose of being a support location for a second gripper of the manipulator of an ROV.

In this way, to perform the rotation of the second turning device (140), the gripper of one of the manipulators of an ROV must hold the “c” shaped joint (12) of the device (100) of the present invention, and the gripper of another manipulator of the ROV must hold the “T” shaped support (15), and perform the rotation according to the positioning in which the second turning device (140) of the device (100) of the present invention must remain.

In this way, using at least two turning devices (130, 140) brings greater flexibility to the device (100), since it makes the coupling of the device (100) to the surface on which the operation will be performed more efficient and practical.

The measuring adapter (150) of the device (100) of the present invention is fixed to one of the two external surfaces of the second turning device (140).

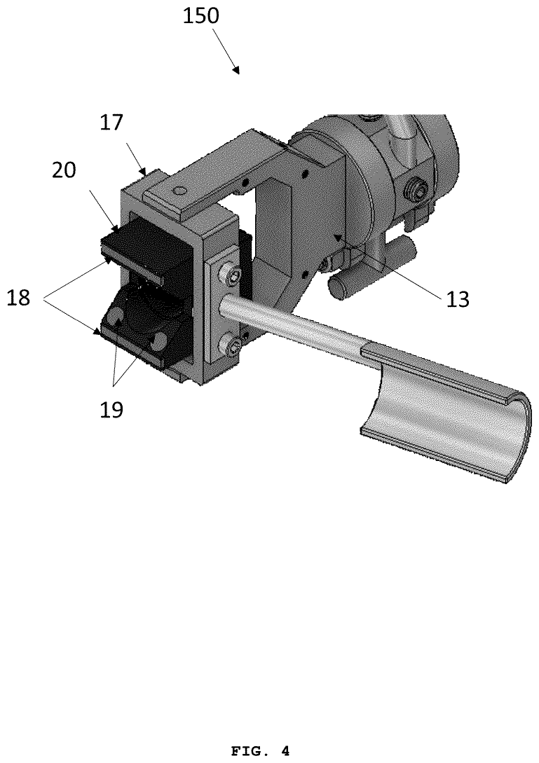

The measuring adapter (150), as can be seen in FIG. 4, comprises: a support (13); a base of the prism (17); a magnet prism (20); at least one pair of rectangular magnets (18); and at least two pairs of circular magnets (19).

The support (13) is fixed to one of the two external surfaces of the second turning device (140), and has an end where the base of the prism (17) is fixed by means of a pivoting fixture.

In this way, the base of the prism (17) is a rectangular base pivoting in relation to the support (13). The base of the prism (17) further receives the magnet prism (20), in which the magnet prism (20) is fixed by means of a pivoting fixture to the base of the prism (17).

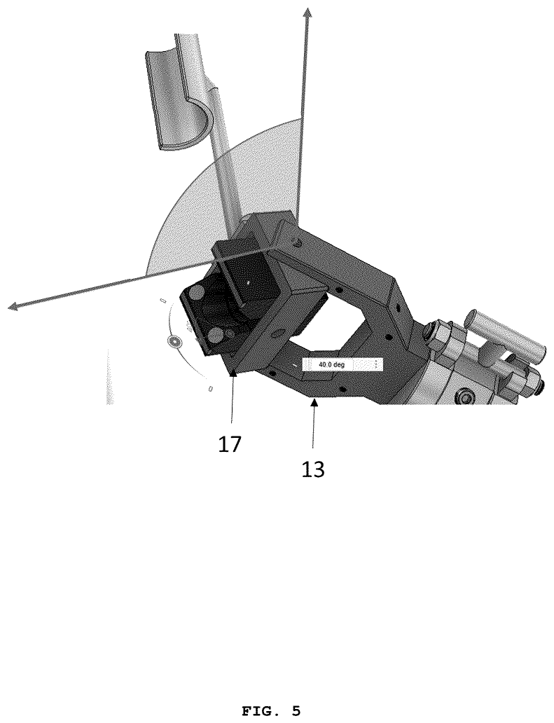

FIG. 5 shows the movement of the base of the prism (17) in relation to the support (13) of the measuring adapter (150) of the device (100).

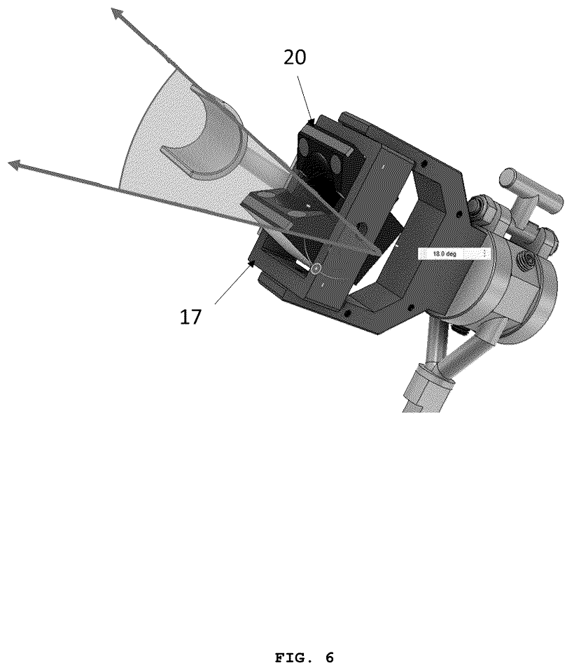

FIG. 6 shows the movement of the magnet prism (20) in relation to the base of the prism (17) of the measuring adapter (150) of the device (100).

The magnet prism (20) further comprises the at least one pair of rectangular magnets (18) and the at least two pairs of circular magnets (19), at their ends which come into contact, partially or totally, with the surface on which the operation of the device (100) will occur.

In this way, the at least one pair of rectangular magnets (18) and the at least two pairs of circular magnets (19) provide a more stable contact with the operating and inspection surface.

The magnets (18, 19) are preferably made of neodymium, forming a magnetic system strong enough to allow the device (100) to be released by the ROV at the inspected site, and the measurement can then be remote, i.e., the ROV can leave the tool coupled and move away from the site. This is a differential and important advantage because in locations with high subsea currents, for example, the ROV can dock the invention and move away, maintaining the high balance of the ROV due to the current away from the subsea structure, ensuring greater safety for the ROV, the subsea structure and the proposed invention.

The magnet prism (20) further comprises a hole through which the inspection/measurement tool is fitted, in which this tool can be a head/transducer of the ultrasonic thickness gauge. This magnet prism (20) is a guide for coupling to the piping.

The measurement adapter (150), as can be seen in FIG. 4, further comprises the mini camera support (16), fixed to the base of the prism (17) by means of screws.

In this way, the mini camera support (16) comprises a surface for placing a mini camera, so that the coupling of the head/transducer of the ultrasonic thickness gauge in the area to be measured can be viewed, which allows inspectors to check whether this contact is efficient.

Therefore, the device (100) of the present invention considerably increases the capacity for measuring thickness in the opposite regions of the piping and also in other hard-to-reach locations. This will increase the quality of the measurements, providing more inputs for analyzing the integrity of the equipment, thus generating greater safety and ensuring SMS.

Thus, the invention, because it does not require an electrical or hydraulic system, is considered more robust and less prone to failure, in addition to being safer for the environment. Regarding its manufacture, it is practical and has a considerable low cost.

In addition, the structural weight of the device of the present invention is much lower compared to devices already existing in the state of the art, generating greater ease of manufacture, maintenance, transportation, handling by the ROV and flexibility of general use, in addition to greater safety in the operations. The size and weight of the proposed invention also allows it to be transported by the ROV itself between the ship and the subsea inspection site.

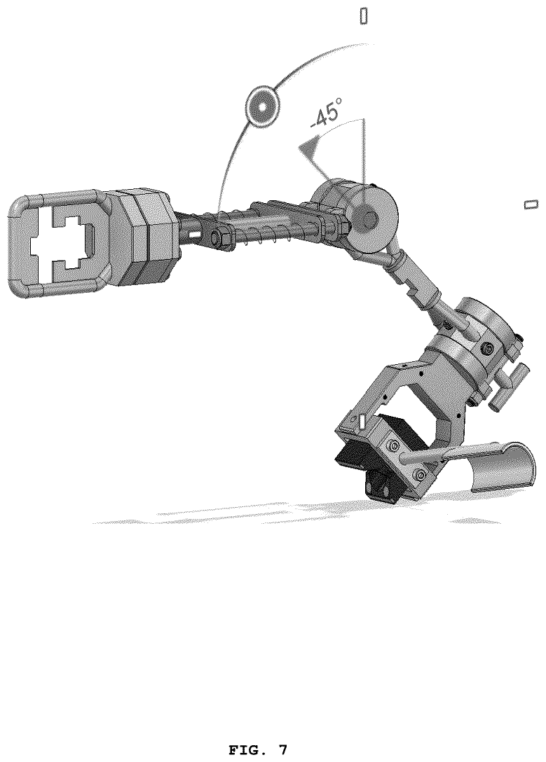

FIGS. 7 to 12 illustrate some of the possible positions of the device for measuring thickness (100) by varying the angle of the at least two turning devices (130, 140), according to the present invention. In total, 98 different possible positions of the device for measuring thickness (100) are possible only by varying the angle of the at least two turning devices (130, 140), according to the present invention. Each turning device (130, 140) can be positioned in 7 different rotating positions. The second turning device (140) may have positioned the measuring adapter (150) on either of its two outer surfaces.

FIG. 7 illustrates the device for measuring thickness (100) with the first turning device (130) in the positioning with a rotation angle of −45°.

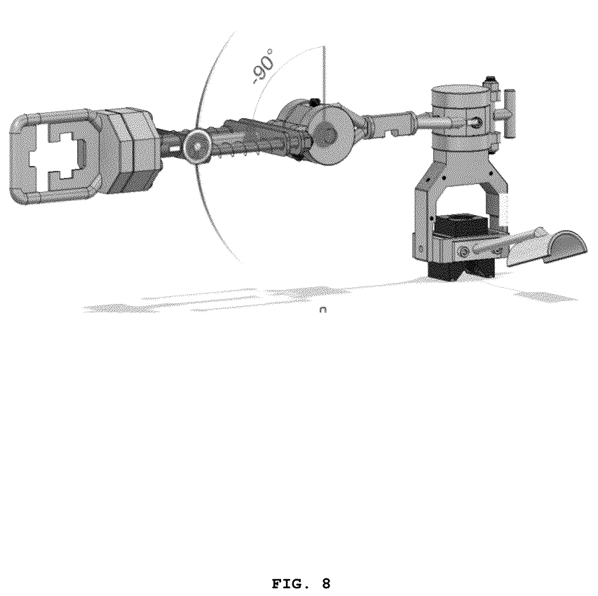

FIG. 8 illustrates the device for measuring thickness (100) with the first turning device (130) in the positioning with a rotation angle of −90°.

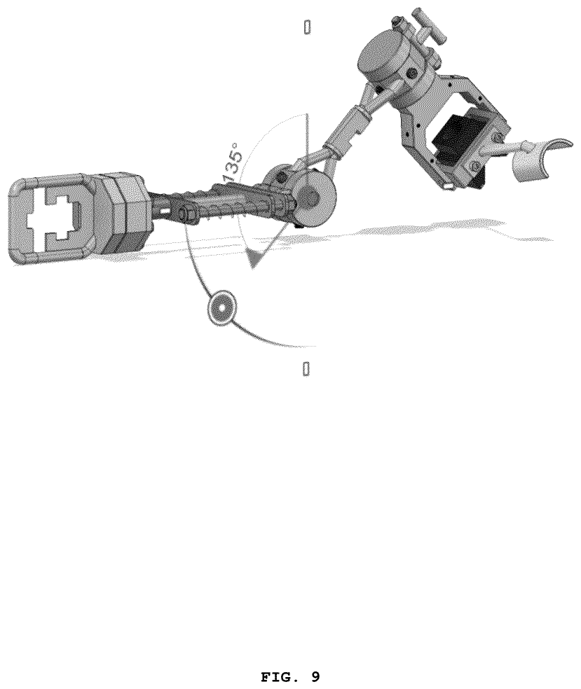

FIG. 9 illustrates the device for measuring thickness (100) with the first turning device (130) in the positioning with a rotation angle of −135°.

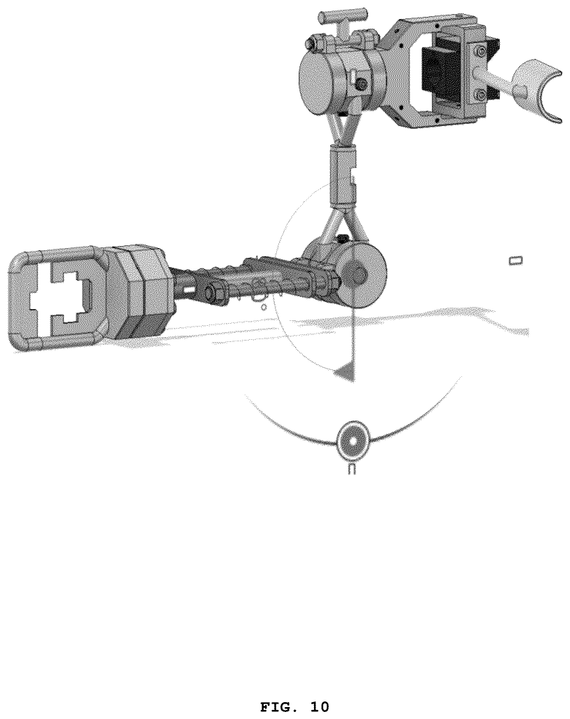

FIG. 10 illustrates the device for measuring thickness (100) with the first turning device (130) in the positioning with a rotation angle of −180°.

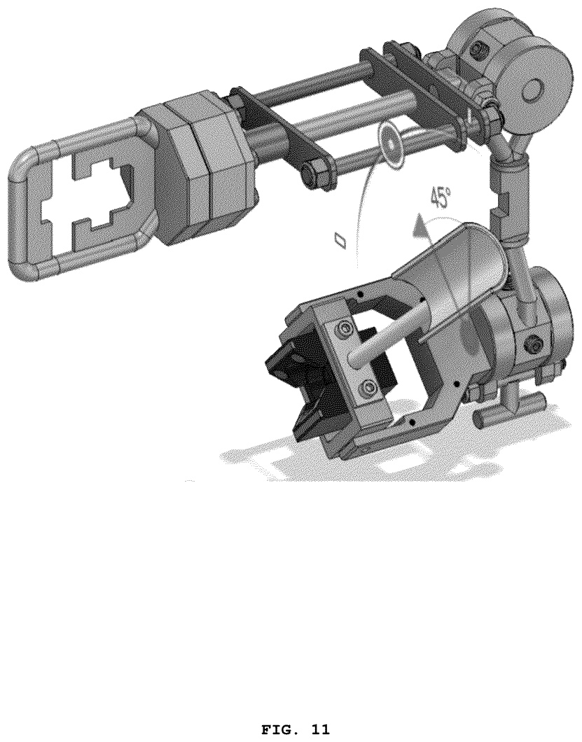

FIG. 11 illustrates the device for measuring thickness (100) with the first turning device (130) in the positioning with a rotation angle of 0° and the second turning device (140) in the positioning with a rotation angle of 45°.

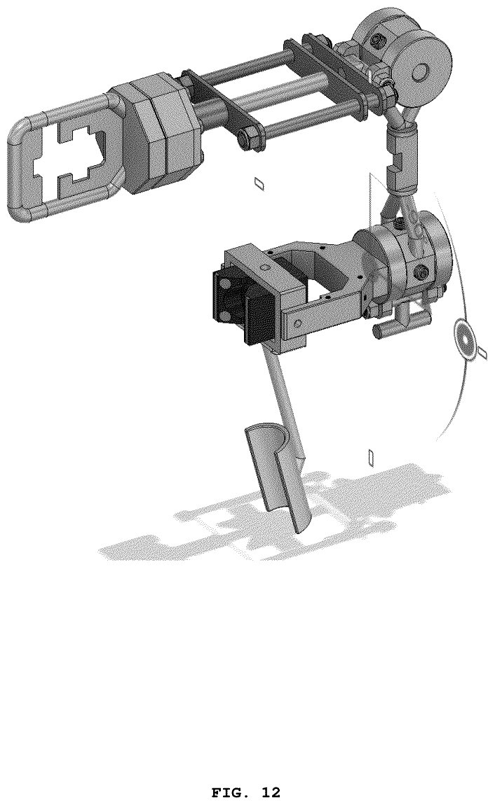

FIG. 12 illustrates the device for measuring thickness (100) with the first turning device (130) in the positioning with a rotation angle of 0° and the second turning device (140) in the positioning with a rotation angle of −90°.

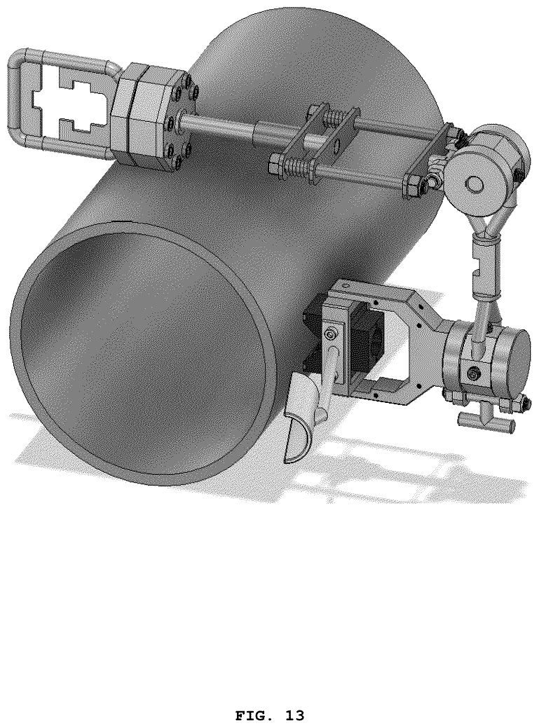

The different formats of the device (100) and its two turning devices (130, 140) provide flexibility for access to hard-to-reach locations, including opposite regions of piping, as can be seen in FIG. 13. In this way, the device of the present invention can operate on all pipe diameters required for subsea inspection, because it can be coupled to any piping diameter and even to non-straight piping, that is, to curved piping, whether radical curves, such as elbows, or to gentler curves, such as goose necks.

Additionally, the implementation of this solution for ships would be extremely common, since the ships need to perform thickness measurements even in hard-to-reach locations. Since they do not currently have a specific solution for this purpose with all the advantages of the device (100) presented herein, the invention proposed herein would bring several benefits.

Those skilled in the art will value the knowledge presented herein and will be able to reproduce the invention in the presented embodiments and in other variants, encompassed by the scope of the attached claims.

What is claimed is:

1. A device for measuring thickness of pipelines comprising:
a manipulator, configured to be a contact region with an ROV;
an impact absorber, configured to absorb a horizontal impact of the device;
at least two turning devices, configured to enable a rotation of the device;
a “c” shaped joint;
a measurement adapter, comprising: a support, a base of the prism, a magnet prism, at least one pair of rectangular magnets, and at least two pairs of circular magnets;
a “T” shaped support; and
a mini camera support.

2. The device according to claim 1, wherein the female fitting of the manipulator is fixed to the impact absorber by welding.

3. The device according to claim 1, wherein a second fixed guide of the impact absorber further comprises a connection to the first turning device of the at least two turning devices.

4. The device according to claim 1, wherein the impact absorber is fixed to an external fixture of the first turning device, in which a bearing fixture is fixed to the “c” shaped joint.

5. The device according to claim 1, wherein the “c” shaped joint is fixed to a bearing fixture of the second turning device.

6. The device according to claim 1, wherein the “T” shaped support is fixed to an external fixture of the second turning device.

7. The device according to claim 1, wherein the support is fixed to one of the two external surfaces of the second turning device, and in which it has an end where the base of the prism is fixed by means of a pivoting fixture.

8. The device according to claim 1, wherein the base of the prism receives the magnet prism, and in which the magnet prism is fixed by means of a pivoting fixture to the base of the prism.

9. The device according to claim 1, wherein the magnetic prism further comprises the at least one pair of rectangular magnets and the at least two pairs of circular magnets, and in which the magnets are preferably made of neodymium.

10. The device according to claim 1, wherein the mini camera support is fixed to the base of the prism by means of screws.
